(19) United States
(12) Patent Application Publication
(10) Pub. No.: US 2012/0272279 A1
(43) Pub. Date: Oct. 25, 2012

(54) APPARATUS FOR PROVIDING INTERNET PROTOCOL TELEVISION BROADCASTING CONTENTS, USER TERMINAL AND METHOD FOR PROVIDING INTERNET PROTOCOL TELEVISION BROADCASTING CONTENTS INFORMATION

(75) Inventors: Young-Hwan LIM, Seoul (KR); Hee-Ae KO, Seoul (KR); Jong-Keun KIM, Hanam-si (KR); Kun-Hoo SIM, Seoul (KR); Mei-Hua ZHAO, Seoul (KR)

(73) Assignee: UNIWEBS CO. LTD., Seoul (KR)

(21) Appl. No.: 13/095,244

(22) Filed: Apr. 27, 2011

(30) Foreign Application Priority Data
Apr. 22, 2011 (KR) 10-2011-0037929

(51) Int. Cl. H04N 7/173

(52) U.S. Cl. 725/109

(57) ABSTRACT

An apparatus and method for providing IPTV broadcasting contents information is provided. The apparatus and method is capable of easily providing a user terminal with related information that is associated with IPTV broadcasting content contents. The apparatus includes a content generator configured to generate an IPTV broadcasting content by use of a broadcasting content and a Quick Response (QR) code including related information that is associated with the broadcasting content, and a transmitter configured to transmit the IPTV broadcasting content.

### CROSS-REFERENCE TO RELATED APPLICATION

This application claims the benefit under 35 U.S.C. §119(a) of Korean Patent Application No. 10-2011-0037929, filed on Apr. 22, 2011, the disclosure of which is incorporated by reference in its entirety for all purposes.

### BACKGROUND

1. Field

The following description relates to an apparatus for providing Internet Protocol Television (IPTV) broadcasting contents, a user terminal and a method for providing Internet Protocol Television (IPTV) broadcasting contents information.

2. Description of the Related Art

Internet Protocol Television (IPTV) is a system through which information services, moving picture contents and broadcasting services are delivered using IP network, that is, high-speed internet. Since the IPTV provides services through high speed internet, users need to have an IPTV set-top box in using IPTV services. The IPTV is not that different from satellite broadcasting, cable broadcasting in providing broadcasting contents including video contents. However, the IPTV further include a two way capability, allowing consumers to enjoy new experience along with the two way capability.

IPTV broadcast providers may provide real time channel services, catch-up services for movie and television programs and User Created Contents (UCC). The IPTV broadcast provider is distinctive by providing a multi angle function in which a user selects a desired camera image among a plurality camera images forming one content. However, the IPTV is served through selecting contents on a menu tree according to a classification system of contents by service providers. Accordingly, a user requires many of manipulations to access contents, and the access to related contents is heavily limited.

In addition, the IPTV provides search functions associated with a conventional portal web site. However, there is a difficulty in entering texts using a remote controller in a television environment, and the IPTV provides a limited level of services that metadata is linked to a search engine to associating recommended search words and linking to a blog, an internet café of a portal site.

### SUMMARY

In one aspect, there is provided an apparatus for providing Internet Protocol Television (IPTV) broadcasting contents, a user terminal and a method for providing Internet Protocol Television (IPTV) broadcasting contents information, capable of easily providing a user terminal with related information associated with IPTV broadcasting contents.

In one general aspect, there is provided an apparatus for providing an Internet Protocol Television (IPTV) broadcasting content. The apparatus includes a content generator and a transmitter. The content generator is configured to generate an IPTV broadcasting content by use of a broadcasting content and a Quick Response (QR) code including related information that is associated with the broadcasting content. The transmitter is configured to transmit the IPTV broadcasting content.

In another general aspect, there is provided a a system comprising an apparatus for providing an Internet Protocol Television (IPTV) broadcasting content, an IPTV configured to receive and display the IPTV broadcasting content and a user terminal having a camera function. The IPTV broadcasting content providing apparatus includes a content generator configured to generate an IPTV broadcasting content by use of a broadcasting content and a Quick Response (QR) code including related information that is associated with the broadcasting content, and a transmitter configured to transmit the IPTV broadcasting content. The user terminal includes a photographer, a controller and a display. The photographer is configured to photograph the IPTV broadcasting content that is displayed through the IPTV. The controller is configured to recognize the QR code from the photographed IPTV broadcasting content, decipher the QR code and extract the related information that is associated with the broadcasting content. The display is configured to display the extracted related information.

In another general aspect, there is provided a method for providing an IPTV broadcasting content information by use of a system comprising an apparatus for providing an Internet Protocol Television (IPTV) broadcasting content, an IPTV configured to receive and display the IPTV broadcasting content and a user terminal having a camera function. The method is as follows. The IPTV broadcasting content providing apparatus generates an IPTV broadcasting content by use of a broadcasting content and a Quick Response (QR) code including related information that is associated with the broadcasting content. The IPTV broadcasting content providing apparatus transmits the IPTV broadcasting content. The IPTV receives and displays the IPTV broadcasting content. The user terminal photographs the IPTV broadcasting content that is displayed through the IPTV. The user terminal recognizes the QR code from the photographed IPTV broadcasting content, deciphers the QR code and extracts the related information that is associated with the broadcasting content. The user terminal displays the extracted related information.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 shows an example of the configuration of a system for providing IPTV broadcasting content information.

FIG. 2 shows an example of the configuration of an apparatus for providing IPTV broadcasting content.

FIG. 3A shows an example of a process of generating an IPTV broadcasting content.

FIG. 3B shows another example of a process of generating an IPTV broadcasting content.

FIG. 4 shows an example of a plurality of QR codes being inserted into a broadcasting content.

FIG. 5 shows an example of a process of providing related information included in image frames forming a broadcasting frame according to replay time of the broadcasting content.

FIG. 6 shows an example of the configuration of a user terminal.

FIG. 7 shows an example of an operation of a user terminal.

FIG. 8 shows another example of an operation of a user terminal.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

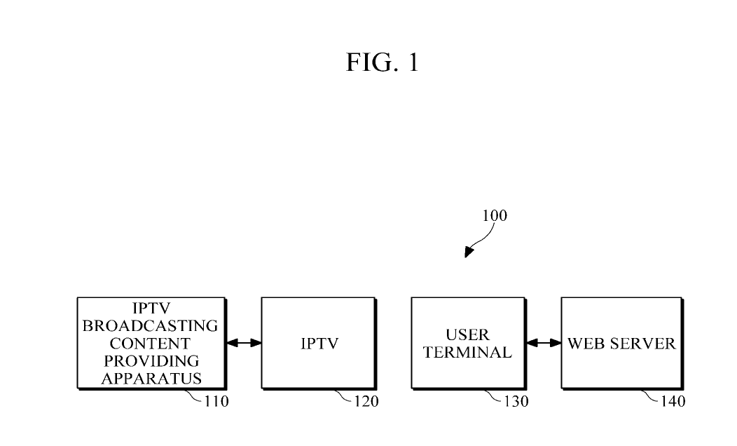

FIG. 1 shows an example of the configuration of a system for providing IPTV broadcasting content information.

A system 100 for providing Internet Protocol Television (IPTV) broadcasting content information includes an apparatus 110 for providing an IPTV broadcasting content, an IPTV 120, a user terminal 130 and a web server 140.

The IPTV broadcasting content providing apparatus 110 provides an IPTV broadcasting content. The IPTV broadcasting content may include video data, text data, audio data and various types of multimedia data. The IPTV broadcasting content providing apparatus 110 generates an IPTV broadcasting content by use of a broadcasting content and a Quick Response (QR) code including related information that is associated with the broadcasting content, and transmits the IPTV broadcasting content. The related information associated with the broadcasting content may be text information, but is not limited thereto. The QR code is a 2-dimensional code formed in a square grid pattern of horizontal and vertical lines in which various types of information are contained. An example of the QR code includes a position detection pattern of the QR code and a data region including related information associated with broadcasting contents.

The IPTV broadcasting content providing apparatus 110 may be connected to the IPTV 120 through a network. In FIG. 1, the IPTV 120 may include a set-top box configured to receive and process IPTV broadcasting contents and a display configured to display the processed IPTV broadcasting contents. The IPTV 120 receives the IPTV broadcasting contents from the IPTV broadcasting content providing apparatus 110 and displays the received IPTV broadcasting contents.

The user terminal 130 may be implemented using various types of electronic devices incorporated with a camera function. The user terminal 130 photographs the IPTV broadcasting contents being displayed through the IPTV 120, recognizes/extracts the QR code inserted into the photographed broadcasting contents, and deciphers the extracted QR code, thereby providing the related information associated with the broadcasting contents.

The user terminal 130 may communicate with the web server 140 through a network. If the broadcasting content related information included in the extracted QR code includes link information for access to a web page which provides related information, the user terminal 130 may download a web page that corresponds to the link information from web server 140. The broadcasting content related information may include detailed information about a broadcasting content, such as the title of a broadcasting content, the sequence information of a broadcasting program and the summary of a broadcasting program, information about an object included in a scene of a broadcasting content, such as manufactured goods or characters, and web site information that provides a shopping service for the product included in the scene of the broadcasting content, but is not limited thereto.

The user terminal 130 may display the downloaded web page through a display. In addition, the user may access new information by selecting link information that is included in a web page, which is downloaded on the user terminal 130, such that additional user interaction is enabled. For example, a web page, which is configured to provide related information associated with a broadcasting content, may include one link information used for watching news that are related to the broadcasting content, another link information for access to a site for shopping a product that is included in the broadcasting content, and another link information for access to a web site that provides broadcasting contents through Internet. The user may selects desired link information among a plurality of pieces of link information included in the web page to access another web page of interest, thereby acquiring desired information

According to this example, by only photographing a scene of the IPTV broadcasting content being displayed on the IPTV 120, the user of the user terminal 130 may easily acquire related information that is associated with the IPTV broadcasting content. Accordingly, the user may perform a real-time news searching for the IPTV broadcasting content, real time purchase for a product appearing in a broadcasting content, detailed information searching about a broadcasting content and an opinion registering while watching the IPTV 120. In addition, the user may join a real time conversation regarding the broadcasting content with another user.

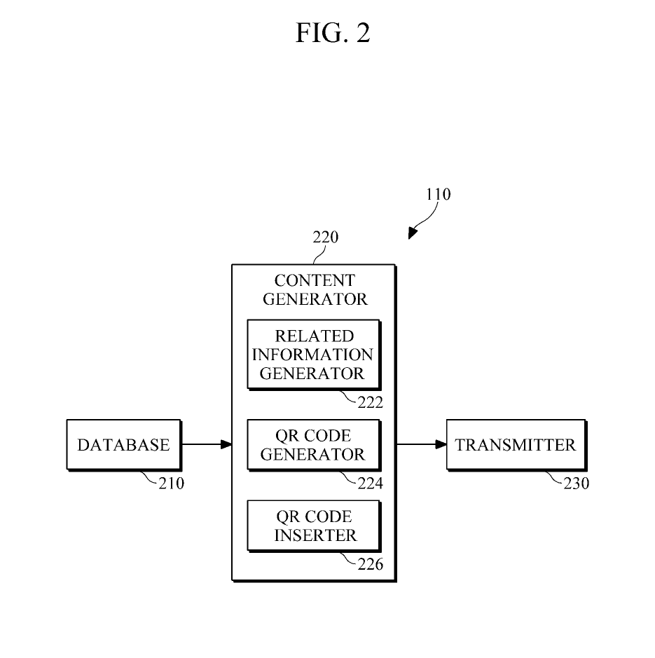

FIG. 2 shows an example of the configuration of an apparatus for providing IPTV broadcasting content.

The IPTV broadcasting content providing apparatus 110 may include a database 210, a content generator 220 and a transmitter 230.

The database 210 may store a plurality of pieces of broadcasting contents and related information associated with the broadcasting contents. Each related information associated with a respective piece of broadcasting content may include link information for access to a web page which provides related information associated with broadcasting contents. The database 210 may be provided outside of the IPTV broadcasting content providing apparatus 110, or may be implemented as an information storage server.

The content generator 220 generates an IPTV broadcasting content by use of a broadcasting content and a Quick Response (QR) code including related information that is associated with the broadcasting content. The content generator 220 may search for a broadcasting content from the database 210, and searches for related information which is associated with the searched broadcasting content from the database 210.

The content generator 220 may generate the IPTV broadcasting content by converting the QR code into an invisible element by use of a watermark scheme and inserting the converted invisible element into the broadcasting content. In addition, the content generator 220 may generate the IPTV broadcasting content by inserting a plurality of QR codes into one image frame forming the broadcasting content.

In addition, the content generator 220 may search for related information that is associated with image frames, which vary with a replay time of the broadcasting content and forms the broadcasting content, from the database 210 according to details of the image frames. The content generator 220 generates a QR code using the searched related information.

The content generator 220 may include a related information generator 222, a QR code generator 224 and a QR code inserter 226.

The related information generator 222 may generate related information by searching for information associated with a broadcasting content, which is provided from the IPTV, from the database 210. In addition, the related information generator 222 may receive related information about a broadcasting content in real time through an external web server or a plurality of web service terminals.

The QR code generator 224 may generate a QR code including related information by converting related information, which is generated in the related information generator 222, into a QR code.

The QR code inserter 226 may generate an IPTV broadcasting content by inserting a QR code into a broadcasting content such as a video file.

The transmitter 230 transmits the IPTV broadcasting content, which is generated in the content generator 220, to a network connected to processing apparatuses including the IPTV 120 shown in FIG. 1 and capable of receiving and processing IPTV broadcasting contents.

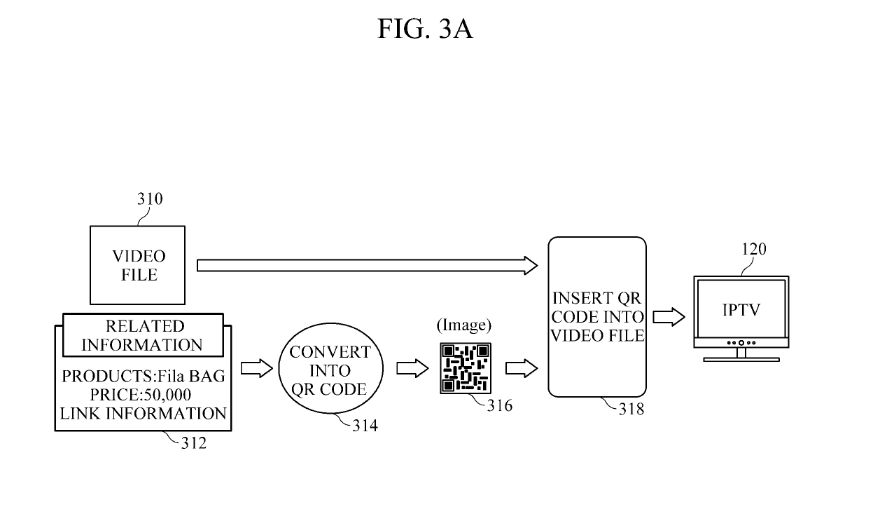

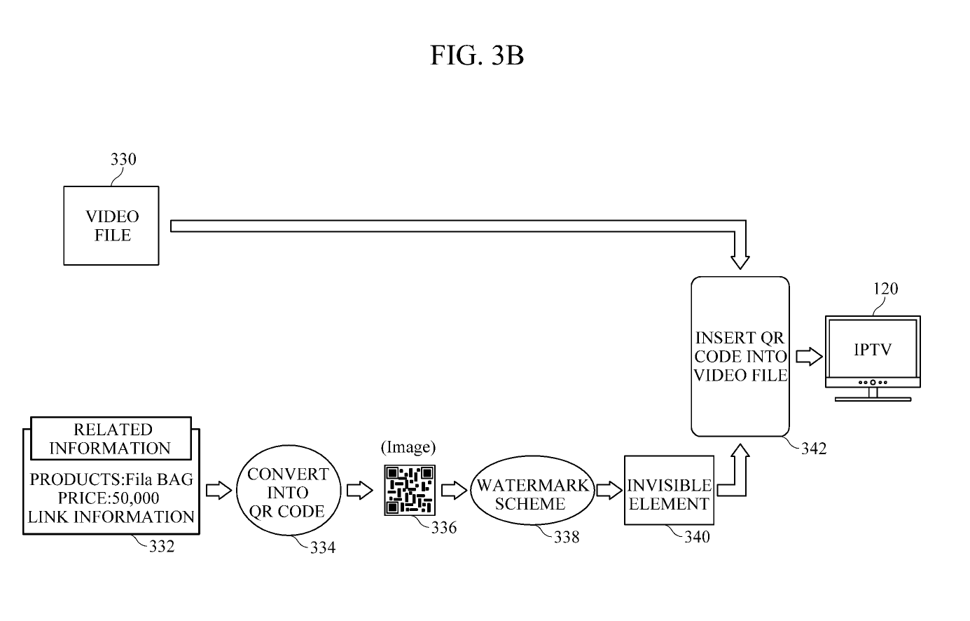

FIG. 3A shows an example of a process of generating an IPTV broadcasting content, and FIG. 3B shows another example of a process of generating an IPTV broadcasting content.

As shown in FIGS. 2 and 3A, the content generator 220 converts related information 312 about a video file 310 corresponding to a broadcasting content into a QR code (314). The content generator 220 generates an IPTV broadcasting content by forming an image of the QR code (316) and inserting the image of the QR code into the video file 310 (318). The IPTV broadcasting content may be transmitted to the IPTV 120 and displayed.

As shown in FIGS. 2 and 3B, the content generator 220 converts related information 332 about a video file 330 into a QR code (334). The content generator 220 forms an image of the QR code (336), and applies a watermark scheme to the image of the QR code (338) to form the image of the QR code into an invisible element (340). The content generator 220 inserts the QR code, which is provided in the form of an invisible element, into the video file 330, thereby generating the IPTV broadcasting content (342). The IPTV broadcasting content may be transmitted to the IPTV 120 and displayed.

The above description has been made as an example of a method for inserting information of a QR code by use of an invisible watermark. However, generally known technologies and advanced technologies to be developed in the future can be adopted in implementing the method. For example, another example of a method of inserting information of a QR code may be achieved by performing a Discrete Cosine Transformation (DCT) and a Wavelet Transformation on an image of a video file 300 to convert the image into frequency domain, and then inserting a QR code, which including related information, into the converted frequency domain video file 300 in the form of an invisible element.

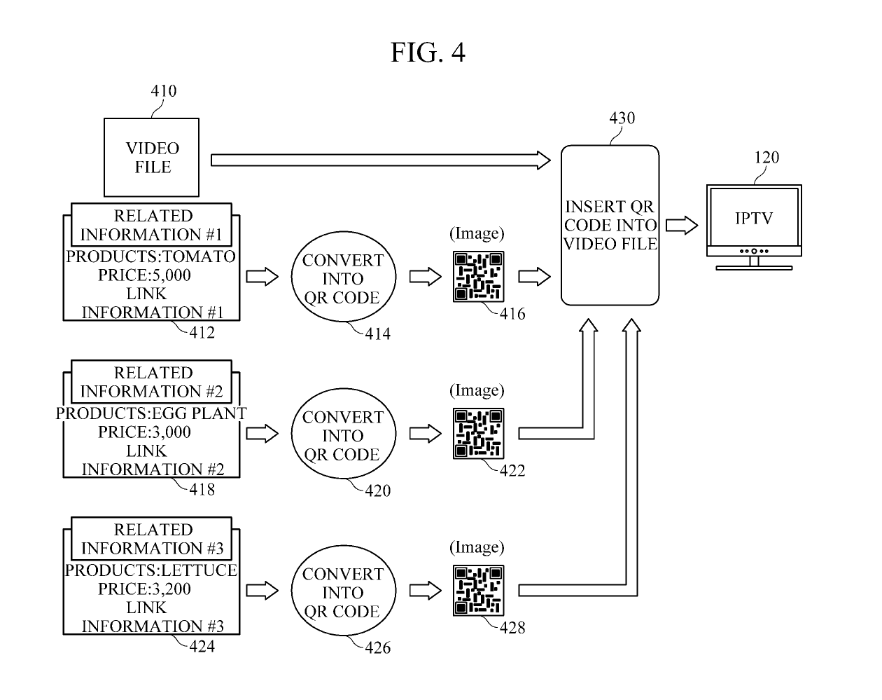

FIG. 4 shows an example of a plurality of QR codes being inserted into a broadcasting content.

In regard to a video file 410 corresponding to a broadcasting content, the content generator 220 shown in FIG. 2 may generate a plurality of pieces of related information 412, 418 and 424. Each of the plurality of pieces of related information 412, 418 and 424 may correspond to a respective object included in an image frame of the video file 410. The plurality of pieces of related information 412, 418 and 424 may represent related information about objects included in an image frame forming the video file 410, including related information #1 412 about tomatoes, related information #2 418 about eggplants, and related information #3 424 about lettuces.

The content generator 220 converts the plurality of pieces of related information 412, 418 and 424 into QR codes (414, 420 and 426), respectively, and forms images of the converted QR codes (416, 422 and 428). The content generator 220 inserts the images of QR codes into the video file 410, thereby generating an IPTV broadcasting content (430). The generated IPTV broadcasting content may be transmitted to the IPTV 120 and displayed.

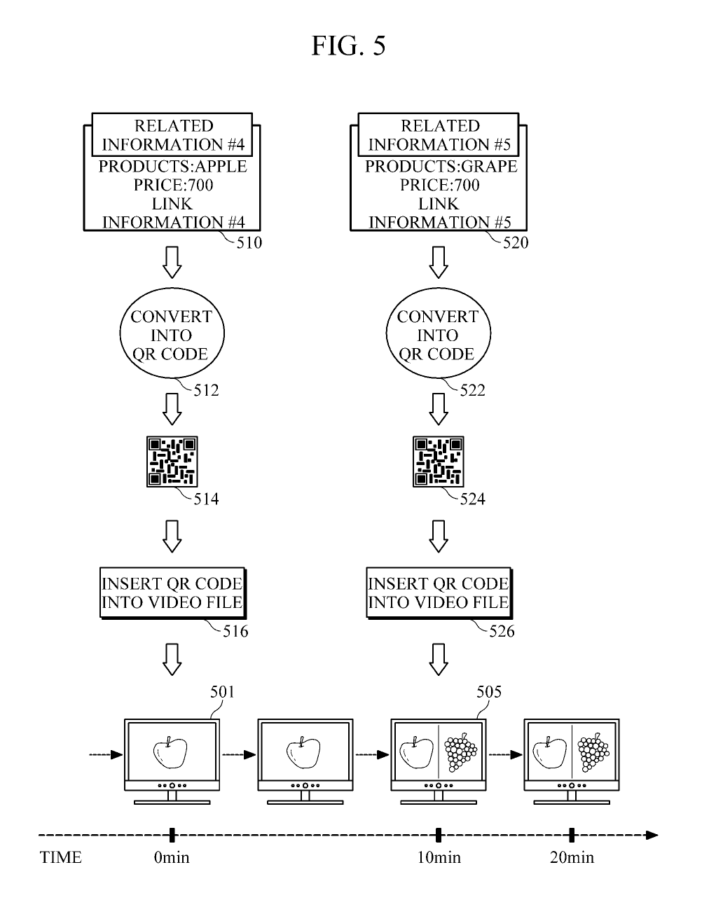

FIG. 5 shows an example of a process of providing related information included in image frames forming a broadcasting frame according to replay time of the broadcasting content.

Since details of a broadcasting content may be changed with a replay time, related information about the corresponding broadcasting content may be also changed with a replay time. For example, at the point in time of 0 minute, apple related information is provided in a broadcasting content 501, and at the point in time of 10 minutes, grape related information is is provided in a broadcasting content 505.

To this end, the content generator 220 shown in FIG. 2 converts the apple related information #4, denoted as reference numeral 510, included in an image frame of a video file at the point of 0 minute into a QR code (512), forms an image of the QR code (514), inserts the image of the QR code into the video file corresponding a broadcasting content (516), thereby generating an IPTV broadcasting content. Accordingly, an IPTV broadcasting content played at the point of 0 minute may include an image frame of the video file played at the point of 0 minute and a QR code including the apple related information 510. In this case, the QR code may be provided in the form of an invisible element and inserted as described in FIG. 3B.

Meanwhile, the content generator 220 shown in FIG. 2 converts the grape related information #5, denoted as reference numeral 520, included in an image frame of a video file at the point of 10 minutes into a QR code (522), forms an image of the QR code (524), inserts the image of the QR code into the video file corresponding a broadcasting content (526), thereby generating an IPTV broadcasting content. Accordingly, an IPTV broadcasting content played at the point of 10 minutes may include an image frame of the video file played at the point of 10 s minutes and a QR code including the grape related information 520. In addition, the image frame of the video file played at the point of 10 minutes may include a QR code including the apple related information 510 and the grape related information 520.

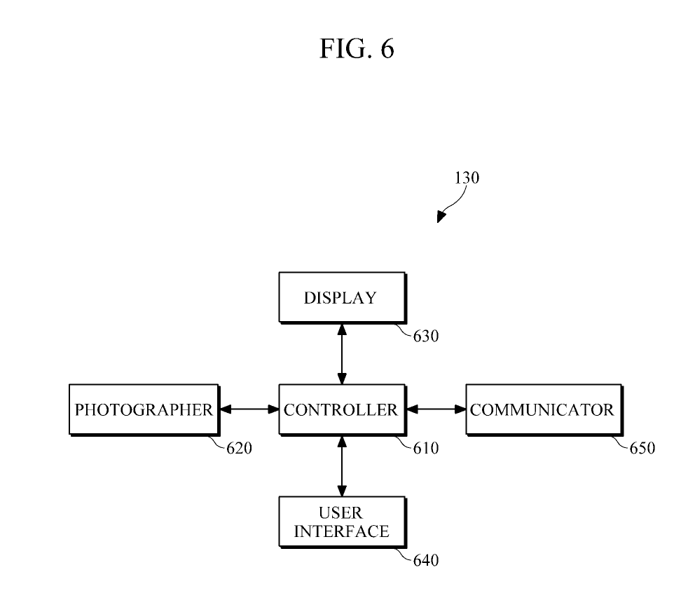

FIG. 6 shows an example of the configuration of a user terminal.

The user terminal 130 includes a controller 610, a photographer 620, a display 630, a user interface 640 and a communicator 650. The user terminal 130 may be implemented in various terminal apparatus equipped with a camera, for example a digital camera, a smart phone, a mobile phone, a Personal Digital Assistant (PDA), and a MPEG-1Audio layer 3 (MP3) player.

The controller 610 controls the photographer 620, the display 630, the user interface 640 and the communicator 650, thereby controlling the overall operation of the user terminal 130. The controller 610 may include an image processor configured to process an image that is acquired by the photographer 620.

The photographer 620 includes a lens, an image sensor, such as a Charge Coupled Device (CCD) and Complementary Metal Semiconductor (CMOS), and an analog-to-digital converter. The photographer 620 converts an image signal, which is generated through capturing an object, into a digital signal, and transmits the digital signal to the controller 610. The controller 610 performs an image processing, such as noise reduction and color sensitivity processing, on the image having been converted into a digital signal. The image having been subject to the image processing in the controller 610 may be stored in a storage (not shown).

The controller 610 is configured to operate an algorithm that is required to run various types of algorithms, which are generally known and to be developed in the future, such as a QR code recognition and decipher algorism and a watermark detection algorithm. If the photographer 620 photographs an IPTV broadcasting content, the controller 610 recognizes and deciphers a QR code from the photographed broadcasting content to extract related information that is associated with the broadcasting content. In addition, even if the QR code is inserted into a broadcasting content as an invisible element, the controller 610 extracts the invisible element from an image of the photographed IPTV broadcasting content, restores the invisible element to the QR code, and recognizes the restored QR code. In addition, the controller 610 may recognize a plurality of pieces of QR codes inserted into the IPTV broadcasting content.

The display 630 includes a display apparatus such as a color Liquid Crystal Display (LCD). The display 630 may display related information that is extracted as the controller 610 performs controlling.

The user interface 640 receives an input signal by a user and transmits the received input signal to the controller 610 such that an operation according to the input signal is performed.

The communicator 650 performs a communication through a network. The communicator 650 connects to the web server 140 shown in FIG. 1, which provides a web site corresponding to link information that is included in related information, and acquires the web site corresponding to the link information that is included in the related information from the web server 140. Information about the acquired web site may be displayed on the display 630 as the controller 610 performs controlling. In addition, as the controller 610 receives an input signal, which is made by the user to select a predetermined piece of information included in a web page accessed through the link information, through the user interface 640, the controller 610 controls the communicator 650 to request a new web page which is connected to the selected predetermined piece of information.

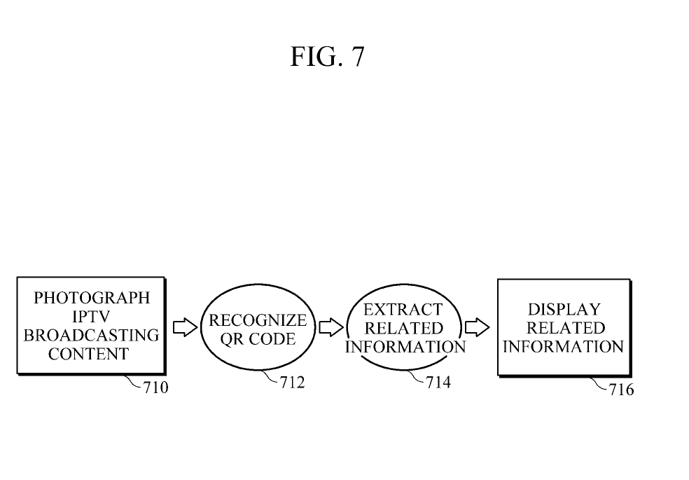

FIG. 7 shows an example of an operation of a user terminal.

The user terminal 130 photographs an IPTV broadcasting content (710). The user terminal 130 recognizes a QR code from the IPTV broadcasting content (712), deciphers the recognized QR code to extract related information from the QR code (714), and displays the extracted related information (716).

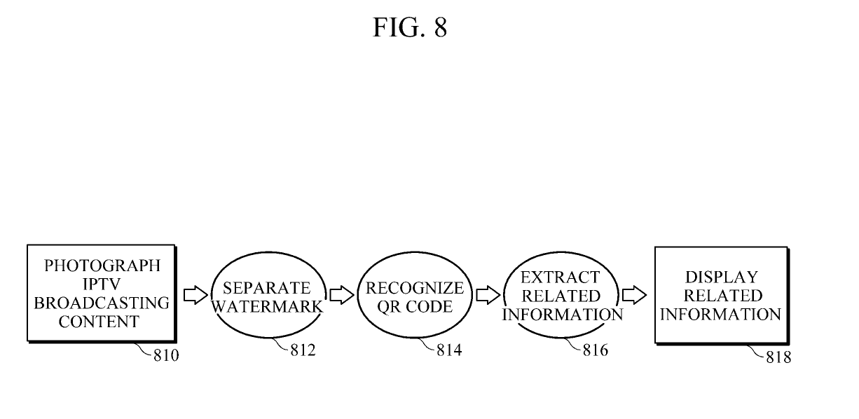

FIG. 8 shows another example of an operation of a user terminal.

The user terminal 130 photographs an IPTV broadcasting content (810). The photographed IPTV broadcasting content may include a watermark into which a QR code is inserted as an invisible element. In this case, the user terminal 130 may separate the watermark from the photographed scene (812). The user terminal 130 recognizes and separates the QR code from the separated watermark (814), deciphers the QR code to extract related information from the QR code (816), and displays the extracted related information (818).

As described above, independent of providing a broadcasting content from an IPTV, a user terminal, such as a smart phone, is serviced with related information about the broadcasting content being played on the IPTV. Accordingly, information about a broadcasting content is easily acquired without affecting the broadcasting content being played on the IPTV. Therefore, users can join a service regarding broadcasting contents in real time, and users are encouraged to purchase manufactured goods that are related to a broadcasting content.

The disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing an Internet Protocol Television (IPTV) broadcasting content, the apparatus comprising:
a content generator configured to generate an IPTV broadcasting content by use of a broadcasting content and a Quick Response (QR) code including related information that is associated with the broadcasting content; and
a transmitter configured to transmit the IPTV broadcasting content.

2. The apparatus of claim 1, wherein the related information associated with the broadcasting content includes link information for access to a web page which provides related information.

3. The apparatus of claim 1, wherein the content generator generates the IPTV broadcasting content by converting the QR code into an invisible element by use of a watermark scheme and inserting the converted invisible element into the broadcasting content.

4. The apparatus of claim 1, wherein the content generator generates the IPTV broadcasting content by inserting a plurality of QR codes into one image frame forming the broadcasting content.

5. The apparatus of claim 1, wherein the content generator searches for related information that is associated with an image frame, which varies with a replay time of the broadcasting content and forms the broadcasting content, according to details of the image frame and generates the searched related information into a QR code.

6. A system comprising an apparatus for providing an Internet Protocol Television (IPTV) broadcasting content, an IPTV configured to receive and display the IPTV broadcasting content and a user terminal having a camera function,
wherein the IPTV broadcasting content providing apparatus comprises: a content generator configured to generate an IPTV broadcasting content by use of a broadcasting content and a Quick Response (QR) code including related information that is associated with the broadcasting content; and
a transmitter configured to transmit the IPTV broadcasting content,
wherein the user terminal comprises:
a photographer configured to photograph the IPTV broadcasting content that is displayed through the IPTV;
a controller configured to recognize the QR code from the photographed IPTV broadcasting content, decipher the QR code and extract the related information that is associated with the broadcasting content; and
a display configured to display the extracted related information.

7. The system of claim 6, wherein the related information associated with the broadcasting content includes link information for access to a web page which provides the related information.

8. The system of claim 7, wherein the user terminal further comprises:
a user interface configured to receive an input by a user; and
a communicator configured to perform a communication through a network,
wherein, upon reception of an input signal by the user to select a predetermined piece of information included in the web page accessed through the link information, the controller controls the communicator to request a new web page, which is connected to the selected predetermined piece of information, through the network.

9. The system of claim 6, wherein the content generator generates the IPTV broadcasting content by converting the QR code into an invisible element by use of a watermark scheme and inserting the converted invisible element into the broadcasting content, and
wherein the controller extracts the converted invisible element, recovers the extracted invisible element into a QR code, and recognizes the recovered QR code.

10. The system of claim 6, wherein the content generator generates the IPTV broadcasting content by inserting a plurality of QR codes into one image frame forming the broadcasting content, and
wherein the controller recognizes the inserted QR codes.

11. The system of claim 6, wherein the content generator searches for related information that is associated with an image frame, which varies with a replay time of the broadcasting content and forms the broadcasting content, according to details of the image frame and generates the searched related information into a QR code.

12. A method for providing IPTV broadcasting content information by use of a system comprising an apparatus for providing an Internet Protocol Television (IPTV) broadcasting content, an IPTV configured to receive and display the IPTV broadcasting content and a user terminal having a camera function, the method comprising:
at the IPTV broadcasting content providing apparatus, generating an IPTV broadcasting content by use of a broadcasting content and a Quick Response (QR) code including related information that is associated with the broadcasting content;
at the IPTV broadcasting content providing apparatus, transmitting the IPTV broadcasting content;
at the IPTV, receiving and displaying the IPTV broadcasting content;
at the user terminal, photographing the IPTV broadcasting content that is displayed through the IPTV;
at the user terminal, recognizing the QR code from the photographed IPTV broadcasting content, deciphering the QR code and extracting the related information that is associated with the broadcasting content; and
at the user terminal, displaying the extracted related information.

13. The method of claim 12, wherein the generating of the IPTV broadcasting content comprises:
converting the QR code into an invisible element by use of a watermark scheme; and inserting the converted invisible element into the broadcasting content.
